(19) United States
(12) Patent Application Publication
(10) Pub. No.: US 2023/0300954 A1
(43) Pub. Date: Sep. 21, 2023

(54) OVERHEAD DOOR APPARATUS

(71) Applicants: Rene Charbonneau, Dalroy (CA); Diane Le Bouthillier, Dalroy (CA)

(72) Inventors: Rene Charbonneau, Dalroy (CA); Diane Le Bouthillier, Dalroy (CA)

(21) Appl. No.: 17/655,303

(22) Filed: Mar. 17, 2022

(51) Int. Cl. E06B 9/08; E06B 7/00; H05B 3/40

(52) U.S. Cl. CPC E06B 9/08; E06B 7/00; H05B 3/40; E05Y 2900/106; H05B 2214/02

(57) ABSTRACT

An overhead door apparatus that is configured to be placed across an opening of a structure wherein the present invention will be adjacent the bottom edge of an overhead door secured to the opening when the overhead door is in a closed position. The present invention includes a body that is elongated in shape. The body includes an integrally formed first segment and second segment that are operable to create a cavity when the body is placed on the ground. Contiguously formed with the body are wing members wherein the wing members extend outward from the body and are configured to have a fastener journaled therethrough. The cavity of the body is configured to have the heating element of the present invention disposed therein wherein the heating element is substantially the length of the body. The body is manufactured from metal so as to conduct heat from the heating element.

### FIELD OF THE INVENTION

The present invention relates generally to overhead door and accessories thereof, more specifically but not by way of limitation, an overhead door apparatus that is positioned on the ground so as to be adjacent the bottom edge of the overhead door when the overhead door is in its closed position, wherein the present invention prevents freezing of the overhead door to the ground.

### BACKGROUND

As is known in the art, overhead doors are commonly utilized for garages and shops where large items and vehicles need access to enter and exit the opening of the structure. Conventional overhead doors will consist of longitudinal segments that are mounted with wheels to tracks on opposing sides of the opening. The door is configured to roll in an upwards-downwards motion to provide access to the opening in the structure. In the closed position the overhead door, specifically the bottom edge of the lowest segment will be superposed the ground. This surface is typically concrete or similar material. It is quite common for overhead doors to be operably coupled to an automatic opener or they can be manually operated to provide opening and closing thereof.

One issue with overhead doors results from exposure to inclement weather. Most overhead doors are exposed to the external environment and as such the weather can create problem with proper operation of the door. By way of example but not limitation, freezing weather can often present an issue and inhibit proper overhead door operation. During freezing weather, ice can accumulate on the ground proximate the bottom edge of the overhead door from both inside and outside of the overhead door. As the ice accumulates proximate the bottom edge of the overhead door the ice will bond with the ground and the door creating a situation where now the overhead door is releasably secured to the ground. This results in an inability for an individual to open the overhead door without first removing the ice buildup that is releasably securing the door in a closed position.

Accordingly, there is a need for an apparatus, that is placed proximate the bottom edge of an overhead door in its closed position wherein the apparatus is configured to provide a temperature that is greater than that of its surroundings so as to inhibit ice formation.

### SUMMARY OF THE INVENTION

It is the object of the present invention to provide an overhead door apparatus that is configured to be placed proximate the bottom edge of an overhead door in its closed position wherein the present invention includes a body that is longitudinal in form.

Another object of the present invention is to provide an apparatus operable to generate a temperature that is greater than that of its surroundings and be placed adjacent a bottom edge of an overhead door in its closed position wherein the body is formed to create a cavity extending between the first end and second end of the body.

A further object of the present invention is to provide an overhead door apparatus that is configured to be placed proximate the bottom edge of an overhead door in its closed position wherein disposed within the cavity is a heating element.

Still another object of the present invention is to provide an apparatus operable to generate a temperature that is greater than that of its surroundings and be placed adjacent a bottom edge of an overhead door in its closed position wherein the body extends generally the length of the bottom edge of the overhead door.

An additional object of the present invention is to provide an overhead door apparatus that is configured to be placed proximate the bottom edge of an overhead door in its closed position wherein the body includes wing members secured thereto.

Yet a further object of the present invention is to provide an apparatus operable to generate a temperature that is greater than that of its surroundings and be placed adjacent a bottom edge of an overhead door in its closed position wherein the wing members are configured to have fasteners journaled therethrough and into the ground so as to secure the body in position.

Another object of the present invention is to provide an overhead door apparatus that is configured to be placed proximate the bottom edge of an overhead door in its closed position wherein in a preferred embodiment the body is manufactured from metal.

Still another object of the present invention is to provide an apparatus operable to generate a temperature that is greater than that of its surroundings and be placed adjacent a bottom edge of an overhead door in its closed position wherein the body in a preferred embodiment is provided in four foot sections but should be understood that alternate lengths could be employed.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

FIG. 2 is an end view of an embodiment of the present invention; and

FIG. 3 is a detailed view of the wing member of the present invention; and

FIG. 4 is a top view of the present invention; and

FIG. 5 is a perspective view of the present invention installed in an exemplary location; and

FIG. 6 is a detailed view of an end of the present invention showing the heating element disposed within the cavity.

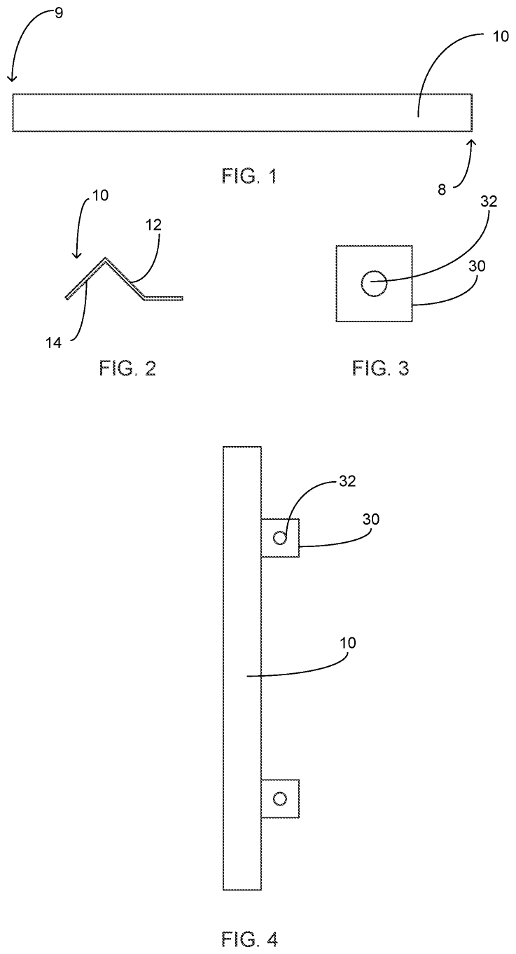

### DETAILED DESCRIPTION

Referring now to the drawings submitted herewith, wherein various elements depicted therein are not necessarily drawn to scale and wherein through the views and figures like elements are referenced with identical reference numerals, there is illustrated an overhead door apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the overhead door apparatus 100 includes a body 10 wherein the body 10 is elongated in manner having first end 8 and second end 9. The body 10 is manufactured from a heat conducting material such as but not limited to metal. The body 10 as illustrated herein in FIG. 2 includes a first segment 12 and a second segment 14. The first segment 12 and second segment 14 are integrally formed and are angularly oriented with each other. The orientation of the first segment and second segment 14 creates a cavity 20 once the lower edges 13,15 of the first segment and second segment 14, respectively, are placed on the ground. In the illustrated example submitted herewith, the first segment 12 and second segment 14 are perpendicular to each other. While a first segment 12 and a second segment 14 are illustrated and discussed herein to form the body 10, it is contemplated within the scope of the present invention that the body 10 could be constructed in alternate manners. By way of example but not limitation, the body 10 could be a single piece being arcuate in form to create a u-shape. Additionally, the body 10 could be manufactured from three integrally formed pieces so as to form a square c-shape and create the cavity so as to function as desired within the scope of the present invention. It should be understood within the scope of the present invention that the body 10 is secured to the floor and constructed so as to allow water to egress underneath. It should be further understood within the scope of the present invention that when the overhead door apparatus 100 is comprised of an installation of more than one body 10 that a void in between each adjacent body 10 will be present so as to permit water flow therethrough.

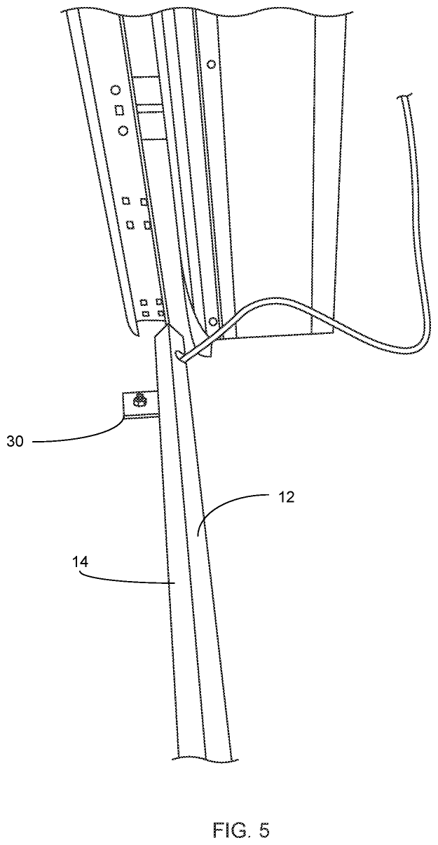

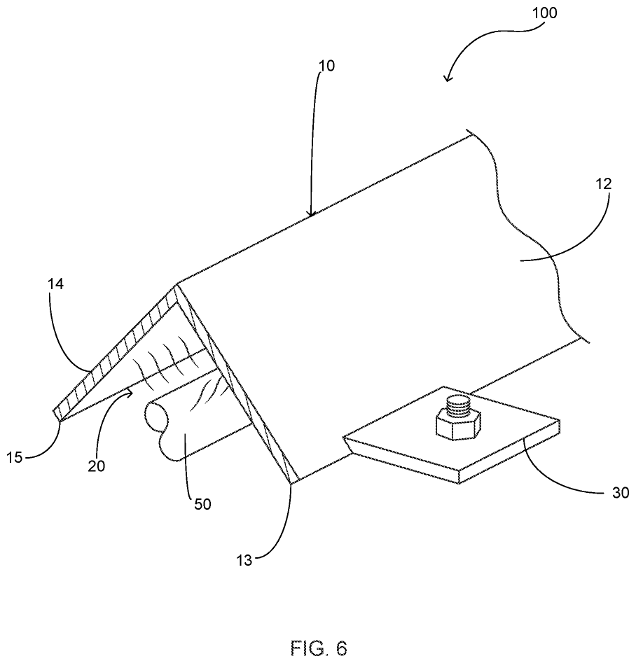

The body 10 has contiguously formed therewith wing members 30. The wing members 30 are square in shape and manufactured from a suitable material such as but not limited to metal. The wing members 30 are square in shape and include a central aperture 32. The central aperture 32 is operable to receive a fastener therethrough so as to secure the wing members 30, and as such the body 10, to the ground in the desired location as shown herein in FIG. 5. While two wing members 30 are illustrated herein, it is contemplated within the scope of the present invention that the overhead door apparatus 100 could have as few as one wing member 30 or more than two. Furthermore, while the wing members 30 are illustrated herein as being square in shape, it should be understood that the wing members 30 could be provided in alternate shapes and sizes.

Referring now to FIG. 6 submitted as a part hereof, the overhead door apparatus 100 includes a heating element 50. The heating element 50 is linear in form and is configured to be disposed within the cavity 20 of the body 10. The heating element 50 is a conventional electrical heating element that is electrically coupled to a suitable power supply(not particularly illustrated herein). The heating element 50 is configured to extend substantially between the first end 8 and second end 9 of the body 10. While an electric heating element is the preferred embodiment for the heating element 50, it is contemplated within the scope of the present invention that the heating element 50 could be provided in alternate embodiments and achieve the desired objective discussed herein.

It should be understood within the scope of the present invention that the body 10 could be provided in sections such as but not limited to four feet in length sections. Additionally, it should be understood within the scope of the present invention that the overhead door apparatus 100 could be placed across the entire span of the opening where the overhead door bottom edge is engaged or only a part thereof. Additionally, while mechanical fasteners are preferred, it should be understood within the scope of the present invention that the body 10 could be chemically adhered in place. Furthermore, it is additionally contemplated within the scope of the present invention that the body 10 could be buried or cast into the concrete in the desired position as opposed to be superposed thereto.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An overhead door apparatus configured to be placed proximate a bottom edge of an overhead door in its closed position and provide a temperature greater than that of its surroundings wherein the overhead door apparatus comprises:
a body, said body being elongated in form, said body having a first end and a second end, said body being formed so as to create a cavity subsequent a first edge and a second edge of said body being superposed a ground;
a heating element, said heating element being configured to be disposed in said cavity of said body, said heating element configured to provide a temperature for said body that is greater than that of environmental surroundings of the body.

2. The overhead door apparatus configured to be placed proximate the bottom edge of the overhead door as recited in claim 1, and further including at least one wing member, said at least one wing member being secured to said body and extending outward therefrom, said at least one wing member further having a centrally located aperture.

3. The overhead door apparatus configured to be placed proximate the bottom edge of the overhead door as recited in claim 2, wherein the centrally located aperture is configured to have a fastener journaled therethrough.

4. The overhead door apparatus configured to be placed proximate the bottom edge of the overhead door as recited in claim 3, wherein said heating element is an electric heating element.

5. The overhead door apparatus configured to be placed proximate the bottom edge of the overhead door as recited in claim 4, wherein said body is manufactured from metal.

6. An overhead door apparatus configured to be placed proximate a bottom edge of an overhead door in its closed position and provide a temperature greater than that of its surroundings wherein the overhead door apparatus comprises:
a body, said body having a first segment and a second segment, said first segment and said second segment being contiguously formed, said first segment and said second segment being perpendicular to each other, said first segment having an outer longitudinal edge, said second segment having an outer longitudinal edge, said body configured to create a cavity subsequent said outer longitudinal edge of said first segment and said outer longitudinal edge of said second segment being superposed a ground;
a plurality of wing members, said plurality of wing members being contiguously secured to said body proximate said outer longitudinal edge of said first segment and said outer longitudinal edge of said second segment, said plurality of wing members being planar in manner, said plurality of wing members having a central aperture configured to have a fastener journaled therethrough; and
a heating element, said heating element being disposed in said cavity of said body, said heating element configured to provide heat to said body.

7. The overhead door apparatus configured to be placed proximate the bottom edge of the overhead door as recited in claim 6, wherein said heating element is an electric heating element.

8. The overhead door apparatus configured to be placed proximate the bottom edge of the overhead door as recited in claim 7, wherein said body is manufactured from metal.
